(19) United States
(12) Patent Application Publication
(10) Pub. No.: US 2024/0311641 A1
(43) Pub. Date: Sep. 19, 2024

(54) ADAPTIVE Q LEARNING IN DYNAMICALLY CHANGING ENVIRONMENTS

(71) Applicant: Technology Innovation Institute - Sole Proprietorship LLC, Masdar City (AE)

(72) Inventors: Reda ALAMI, Masdar City (AE); Hakim HACID, Masdar City (AE)

(73) Assignee: Technology Innovation Institute - Sole Proprietorship LLC, Masdar City (AE)

(21) Appl. No.: 18/602,351

(22) Filed: Mar. 12, 2024

Related U.S. Application Data
(60) Provisional application No. 63/490,160, filed on Mar. 14, 2023.

(51) Int. Cl. G06N 3/092; G05D 1/644; G05D 101/15; G05D 109/20

(52) U.S. Cl. CPC G06N 3/092; G05D 1/644; G05D 2101/15; G05D 2109/20

(57) ABSTRACT

Systems, methods, and computer-readable media for dynamic changes to both a learned control policy in the event of a change in the environment (e.g., introduction of a new or unseen obstacle). Rather than having to implement an entirely new policy (and a new global Q table), which can delay performance of tasks by agent(s), the present embodiments allow for a reduced delay in updating local Q table(s) based on detection of a new change in the environment. Locally changing the policy allows for more efficient updating of the policy based on changes in the environment, rather than globally changing the Q table after each change. Particularly in an event with multiple changes in the environment, the present embodiments increase efficiency in updating local and global Q tables while also reducing a delay in providing new instructions to the agent(s) in completing tasks.

### CROSS-REFERENCE TO RELATED APPLICATION

This application claims priority to U.S. Provisional Application Ser. No. 63/490,160, filed Mar. 14, 2023, which is incorporated by reference in its entirety.

### TECHNICAL FIELD

This disclosure relates to systems, methods, and computer-readable media for dynamically changing a Q learning policy based on a detected change to an environment.

### BACKGROUND

Reinforcement learning generally relates to an area of machine learning concerned with determining how an agent ought to take an action in an environment in order to maximize a reward. Q learning can include a model-free reinforcement learning algorithm to learn the value of an action in a particular state. For example, a computer can implement a Q learning model to determine a shortest (or best) path for a vehicle (e.g., an unmanned aerial vehicle (UAV) or drone) to travel to a target location to perform an action. Further, a reward can be issued based on deriving the shortest path to the target location.

In many cases, the Q learning algorithm generates a policy for an environment in a current configuration of the environment. In the event that the configuration of the environment changes (e.g., a new obstacle is introduced in the environment), these algorithms may not be able to account for such a change.

### SUMMARY

The present embodiments relate to systems, methods, and computer-readable media for dynamic changes to both a learned control policy in the event of a change in the environment (e.g., introduction of a new or unseen obstacle). Rather than having to implement an entirely new policy (and a new global Q table), which can delay performance of tasks by agent(s), the present embodiments allow for a reduced delay in updating local Q table(s) based on detection of a new change in the environment. Locally changing the policy allows for more efficient updating of the policy based on changes in the environment, rather than globally changing the Q table after each change. Particularly in an event with multiple changes in the environment, the present embodiments increase efficiency in updating local and global Q tables while also reducing a delay in providing new instructions to the agent(s) in completing tasks.

In a first example embodiment, a method for updating a learned control policy in response to identifying a change to an environment is provided. The method can include generating a learned control policy for an environment using a reinforcement learning process. The learned control policy can provide a Q table comprising values specifying actions for an agent to take based on a state of the agent in order to complete a task.

In some instances, the agent comprises an unmanned aerial vehicle (UAV). Further, in some instances, the task comprises the UAV moving from an initial location to a target location in the environment. In some instances, the method can include identifying a state of the UAV based on a present location of the UAV in the environment and determining an action for the UAV based on mapping the state of the UAV to the Q table. In some instances, a reward is issued upon completion of the task, and wherein an amount of the reward is determined based on a length of a path traveled by the UAV in completion of the task.

The embodiments can also include detecting a change to the environment at a first location in the environment. In some instances, the change to the environment comprises a new object being identified at the first location in the environment. In some instances, the embodiments can include receiving, from an image sensor of the agent, an image of the environment and processing the image to identify the new object at the first location in the environment.

The embodiments can also include defining a local region surrounding the first location, wherein the local region corresponds with a local Q table that is part of the Q table.

The embodiments can also include modifying the local Q table using the reinforcement learning process based on the detected change to the environment. In some instances, the reinforcement learning process comprises a Q learning process. In some instances, each local region in the environment corresponds to a cell in the Q table.

The embodiments can also include generating a diffusion model for propagating changes made in the local Q table across the Q table.

The embodiments can also include propagating, using the diffusion model, the changes made in the local Q table globally across the Q table to modify the learned control policy.

In another example embodiment, a system is provided. The system can include at least one unmanned aerial vehicle (UAV) and a computer in electrical communication with the at least one UAV. The computer can be operative to detect a change to the environment at a first location in the environment. A learned control policy for the environment includes a Q table that comprises values specifying actions for an UAV to take based on a state for the UAV to complete a task.

In some instances, the task comprises the UAV delivering a payload from an initial location to a target location in the environment, and wherein the state of the UAV is based on a current location of the UAV in the environment. In some instances, the embodiments can be further operative to identify the state of the UAV based on current location of the UAV in the environment and determine an action for the UAV based on mapping the state of the UAV to the Q table. In some instances, a reward is issued upon completion of the task. An amount of the reward is determined based on a length of a path traveled by the UAV in completion of the task.

The embodiments can be further operative to define a local region surrounding the first location. The local region can correspond with a local Q table that is part of the Q table. The computer is further operative to modify the local Q table using the Q learning process based on the change to the environment.

The embodiments can be further operative to propagate any changes made in the local Q table globally across the Q table to modify the learned control policy. In some instances, the embodiments can be further operative to generate a diffusion model for propagating any changes made in the local Q table across the Q table.

Another example embodiment provides a computer-readable storage medium. The computer-readable storage medium can contain program instructions for a method being executed by an application, the application comprising code for one or more components that are called by the application during runtime, wherein execution of the program instructions by one or more processors of a computer system causes the one or more processors to perform steps.

The embodiments can include generating a learned control policy for an environment using a reinforcement learning process. The learned control policy can provide a Q table comprising values specifying actions for an agent to take based on a state of the agent in order to complete a task.

In some instances, the agent comprises an unmanned aerial vehicle (UAV). In some instances, the task comprises the UAV moving from an initial location to a target location in the environment. In some instances, the steps can also include identifying a state of the UAV based on a present location of the UAV in the environment and determining an action for the UAV based on mapping the state of the UAV to the Q table.

The embodiments can also include detecting a change to the environment at a first location in the environment by receiving, from an image sensor of the agent, an image of the environment and processing the image to identify the new object at the first location in the environment.

In some instances, the change to the environment comprises a new object being identified at the first location in the environment. In some instances, each position in the environment corresponds to a cell in the Q table.

The embodiments can also include defining a local region surrounding the first location. The local region can correspond with a local Q table that is part of the Q table. The embodiments can also include modifying the local Q table using the reinforcement learning process based on the detected change to the environment.

The embodiments can also include generating a diffusion model for propagating changes made in the local Q table across the Q table. The embodiments can also include propagating, using the diffusion model, the changes made in the local Q table globally across the Q table to modify the learned control policy.

This Summary is provided to summarize some example embodiments, so as to provide a basic understanding of some aspects of the subject matter described in this document. Accordingly, it will be appreciated that the features described in this Summary are merely examples and should not be construed to narrow the scope or spirit of the subject matter described herein in any way. Unless otherwise stated, features described in the context of one example may be combined or used with features described in the context of one or more other examples. Other features, aspects, and advantages of the subject matter described herein will become apparent from the following Detailed Description, Figures, and Claims.

### BRIEF DESCRIPTION OF THE DRAWINGS

The above and other aspects of the disclosure, its nature, and various features will become more apparent upon consideration of the following detailed description, taken in conjunction with the accompanying drawings, in which like reference characters may refer to like parts throughout, and in which:

FIG. 1A depicts an example representation of an environment according to an embodiment.

FIG. 1B illustrates an example environment divided into multiple regions according to an embodiment.

FIG. 1C depicts an environment illustrating an example shortest path according to an embodiment.

FIG. 1D illustrates an environment with a selected path P1 and multiple regions defined for the environment according to an embodiment.

FIG. 2A illustrates an example environment in which a new obstacle obstructs the path selected for the agent to reach the target location according to an embodiment.

FIG. 2B illustrates an example environment after detecting a new (or unseen) obstacle according to an embodiment.

FIG. 3 is a flow process of an example method for dynamically changing a Q learning policy based on a detected change to the environment according to an embodiment.

FIG. 4A illustrates a Q function learned during an initial training by a Q learning function according to an embodiment.

FIG. 4B illustrates the Q function with a modified local Q table comprising a local region around the location of the change to the environment according to an embodiment.

FIG. 4C illustrates the Q function with a modified global Q table based on the change to the environment according to an embodiment.

FIG. 5 illustrates an example system for implementing a Q learning technique in a dynamically changing environment according to an embodiment.

FIG. 6 is a block diagram of a special-purpose computer system according to an embodiment.

### DETAILED DESCRIPTION

Reinforcement learning generally relates to an area of machine learning concerned with determining how an agent ought to take an action in an environment in order to maximize a reward. Q learning can include a model-free reinforcement learning algorithm to learn the value of an action in a particular state. For example, a computer can implement a Q learning model to determine a shortest (or best) path for a vehicle (e.g., an unmanned aerial vehicle (UAV), a drone, or an autonomous vehicle capable of carrying a cargo) to travel to a target location to perform an action. Further, a reward can be issued based on deriving the shortest path to the target location.

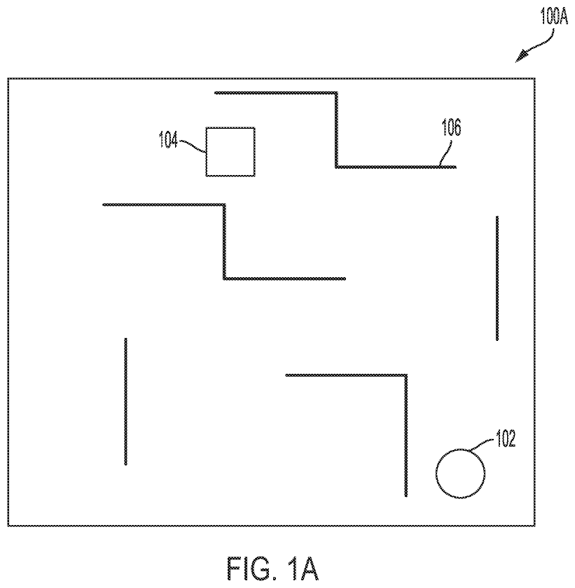

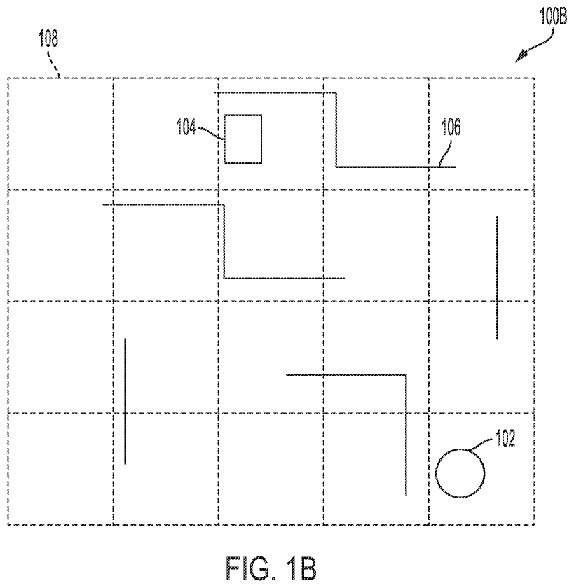

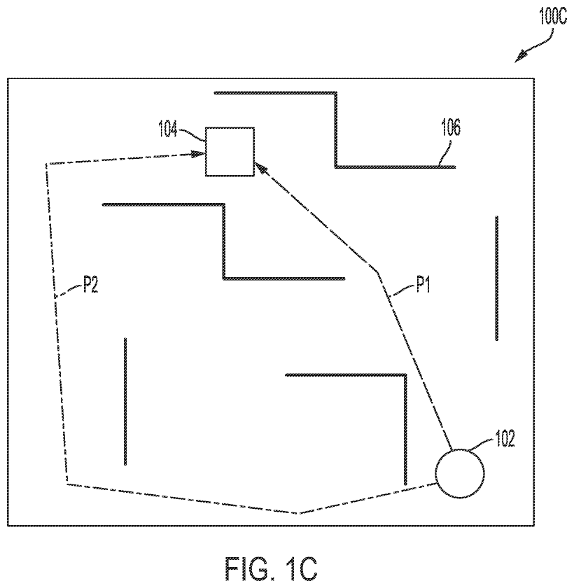

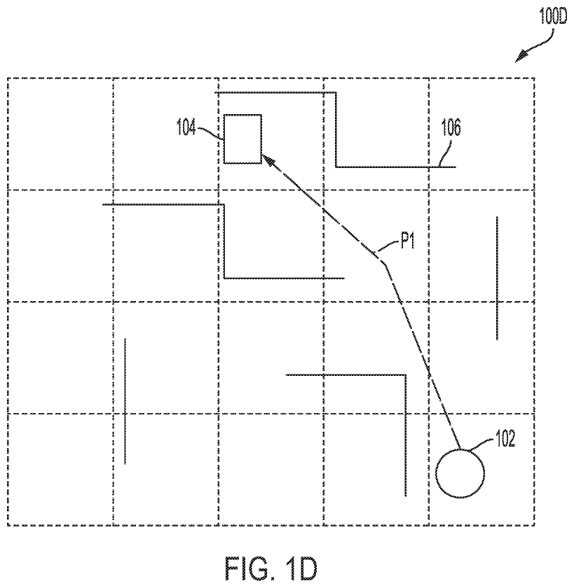

FIGS. 1A-1D illustrate various views of an example environment 100A-D. For example, the environment 100A in FIG. 1A depicts an example representation of an environment (e.g., a city, region, building). Further, the environment 100A can include an agent 102, such as a UAV, or another similar vehicle. The environment 100A can also include a target location 104 for the agent 102 to reach to perform an action (e.g., to deliver a payload, to patrol a location).

A computing node (or a series of interconnected computing nodes) can implement a reinforcement learning or Q learning technique to derive a shortest path for the agent 102 to perform an action (e.g., to reach the target location 104). Particularly, the computing node can identify all obstacles (e.g., obstacle 106) in the environment in determining a path for the agent 102.

The computing node can divide the environment into regions and assign state(s) for each region as part of the Q learning algorithm. FIG. 1B illustrates an example environment 100B divided into multiple regions. Each region (e.g., region 108) can be part of a q-table or matrix that assigns a state to each region. The q-table can become a reference table for selecting the best action based on a q-value for the agent. The Q learning algorithm can then allow for specific actions to be taken by the agent 102 in each region to follow the path designated for the agent 102 to reach the target location 104.

As noted above, the computing node can implement a Q learning algorithm to identify a shortest path for the agent to reach a target location. FIG. 1C depicts an environment 100C illustrating an example shortest path. For instance, as shown in FIG. 1C, the computing node can determine a shortest path (e.g., path P1) for the agent 102 to reach the target location 104 while avoiding any obstacles (e.g., 106) in the environment. A reward can be provided based on the length of the path, incentivizing a shortest or best path for the agent to travel to the target location. For example, while other paths (e.g., path P2) could be set for the agent 102, the shortest path (e.g., path P1) can maximize an award given for selecting the path.

FIG. 1D illustrates an environment 100D with a selected path P1 and multiple regions defined for the environment. As shown in FIG. 1D, each region can specify a state and an action for the agent 102 to take as the agent 102 moves through the environment to implement the selected path P1. In some instances, after reaching the target location 104, the agent 102 can traverse to a starting location or another specified location as defined in the policy derived as a result of the Q learning algorithm.

In many cases, the Q learning algorithm generates a policy for an environment in a current configuration of the environment. In the event that the configuration of the environment changes (e.g., a new obstacle is introduced in the environment), these algorithms may not be able to account for such a change. As an example, the configuration of the environment can change when an unknown vehicle (e.g., a helicopter) enters the environment.

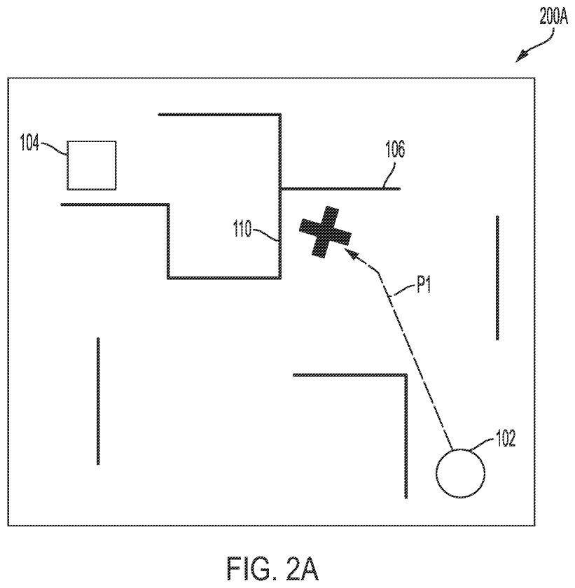

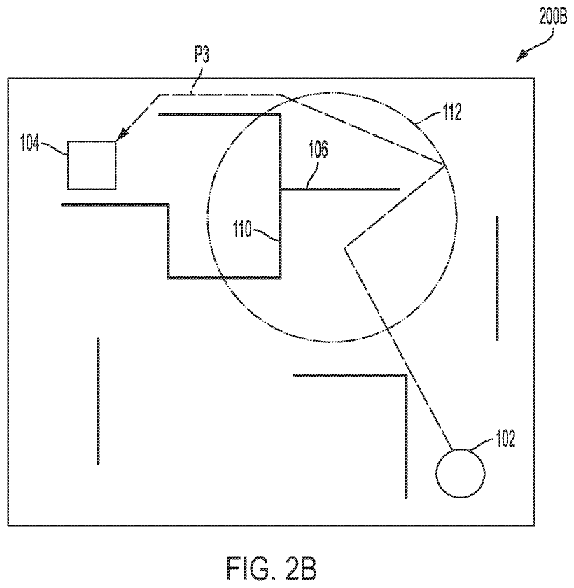

FIG. 2A illustrates an example environment 200A in which a new obstacle 110 obstructs the path selected for the agent 102 to reach the target location 104. In this event, without a change to the policy (and a change to the selected path P1), the agent 102 may be unable to follow the selected path. In many instances, the agent 102 may crash into the obstacle 110, rendering the agent unable to complete the task.

In many cases, a new policy using the Q learning algorithm may need to be generated to account for the new obstacle in the environment. This can result in a delay in providing a new policy for the agent 102, which can result in delayed performance in completing the task or draining of a battery or other fuel source waiting for the new policy, for example.

The present embodiments relate to dynamically updating a learned policy/strategy during execution of the policy in the environment in the event of detecting a change in the environment. The update to the policy can first be performed locally at a region near the change to the environment, and then the policy can be propagated across the entire policy for the environment.

The policy can be dynamically updated in a series of steps. After identifying a new change to the environment (e.g., a new or unseen obstacle), a region (or neighborhood) adjacent to a location of the new change to the environment can be defined. Further, the Q function can be updated in the defined region to designate changes to the local Q table. Further, a diffusion model can propagate any changes in the local Q table to the global Q table.

For example, as shown in FIG. 2B, after detecting a new (or unseen) obstacle 110, the Q function can be updated to account for this change. A computing node can identify a location of the new change (e.g., 110) and identify a region (or neighborhood) 112 around the new change. The new change to the policy can propagated globally, and the new path P3 can be selected as the new shortest path taking into account the new change to the environment.

The present embodiments allow for dynamic changes to both a local Q table and global Q table in the event of a change in the environment (e.g., introduction of a new or unseen obstacle). Rather than having to implement an entirely new policy (and a new global Q table), which can delay performance of tasks by agent(s), the present embodiments allow for a reduced delay in updating local Q table(s) based on detection of a new change in the environment. Locally changing the policy allows for more efficient updating of the policy based on changes in the environment, rather than globally changing the Q table after each change. Particularly in an event with multiple changes in the environment, the present embodiments increase efficiency in updating local and global Q tables while also reducing a delay in providing new instructions to the agent(s) in completing tasks.

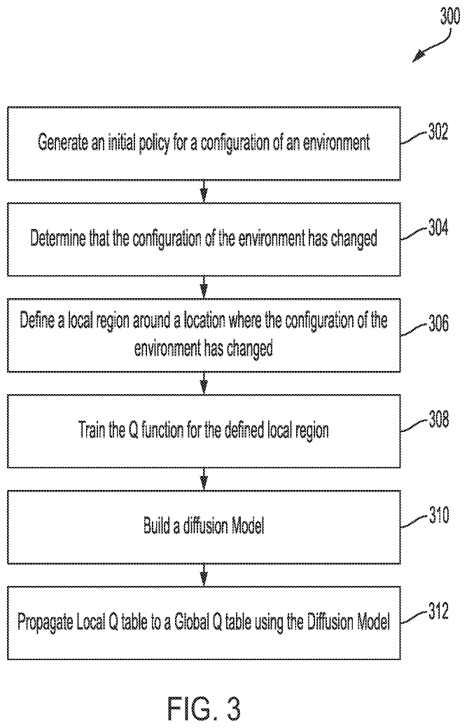

FIG. 3 is a flow process of an example method 300 for dynamically changing a Q learning policy based on a detected change to the environment. A computing node (or series of interconnected computing nodes) can implement the method as described herein.

At 302, the method can include generating an initial policy for a configuration of an environment. The policy can include a result from a reinforcement learning (or Q learning) model analyzing an environment and tasks for one or more agents to take within the environment. For example, the policy can provide a local Q table for each region in the environment and a global Q table for the entire environment. The policy can provide instructions for an agent to perform actions in the environment to perform a task. An example agent can include a UAV attempting to deliver a payload from a starting location to a target location. The policy can accommodate a plurality of agents performing different tasks in the environment, such as multiple UAVs individually performing different tasks in the environment.

At 304, the method can include determining that the configuration in the environment has been changed. A change in the environment can include a new obstacle in the environment or another object being disposed within the environment. For example, a new building or fence can be added in an environment, or another vehicle (e.g., a helicopter) can move into the environment. Such a change can be detected by an agent (e.g., a camera on a UAV), by inspecting a radar/wireless communication system, or by the computing node otherwise receiving an indication of the change to the environment.

As noted above, the change in the environment can lead to one or more agents being unable to perform a task with the current policy. For example, a UAV may be unable to reach a target location due to an obstacle in the environment. This can lead to the UAV, acting according to an initial policy, crashing into the obstacle or stalling in front of the obstacle.

At 306, the method can include defining a local region around a location where the configuration of the environment has changed. The computing node can identify a location where the change to the environment (e.g., the obstacle) is located. Further, the computing node can define a local region (and a local Q table corresponding with the local region) surrounding the change in the environment.

At 308, the Q function can be trained for the defined local region. For instance, the Q function can modify the local Q table to account for the change in the environment. The local Q table can dictate an action that the agent takes given a state of the agent (e.g., the current position of the agent in the environment) with a highest Q value (e.g., a value used to determine how good an action taken at a particular state is to achieve a best path for completing the task).

At 310, a diffusion model can be built. A diffusion model can provide an estimation of scale/size of the neighborhood impacted by the addition/removal of an obstacle. A diffusion model can include a machine learning model that is a type of latent variable model. The diffusion model can learn a latent structure of a dataset (e.g., the local Q table and the global Q table) by modeling how the dataset can diffuse through the latent space. The diffusion model can be used to propagate the local Q table that was modified to account for the change in the environment globally across the global Q table.

The local Q table can be propagated back to the initial model to integrate the new observation. This propagation can be operated on a time or frequency basis. In both cases, a merge operation can be executed on the existing model and the local model (e.g., the Q table and the local Q table). Any of two potential strategies can be implemented: (1) propagation with replacement and (2) propagation with memory. In propagation with replacement, the two Q tables can be merged, with the local Q table overriding the part of the initial Q table representing the initial situation. On the other hand, in propagation with memory, every situation can be kept in memory and the best matching can be completed on the fly (with the latest local Q table being the default one).

At 312, the method can include propagating the local Q table to the global Q table using the diffusion model. This can include modifying Q values globally for the environment based on the changes specified for the local Q table. The modified global Q table can specify an updated policy that accounts for the change in the environment.

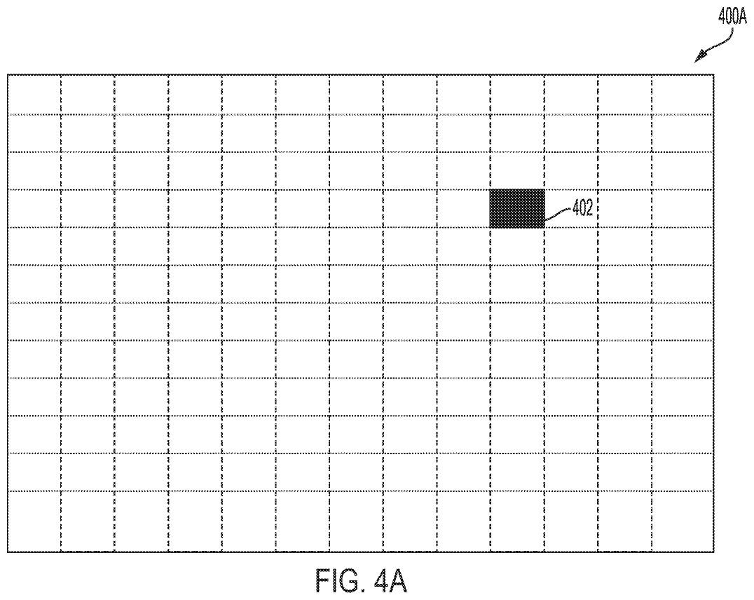

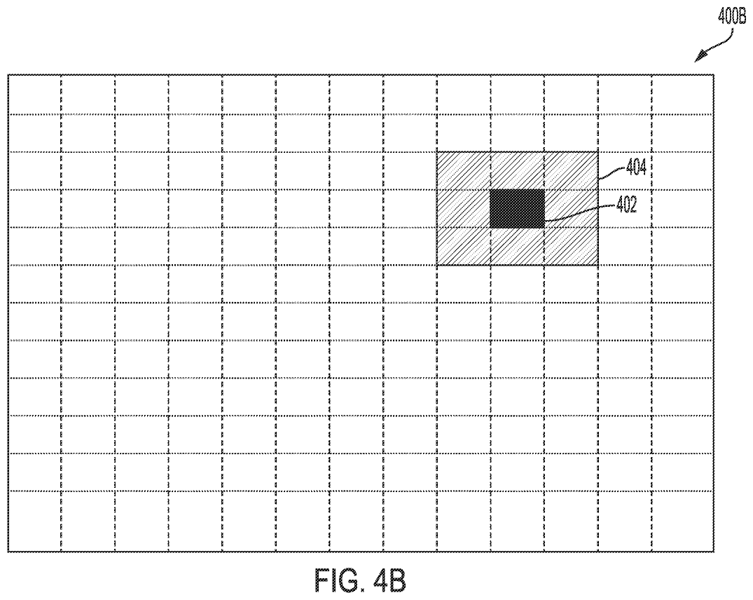

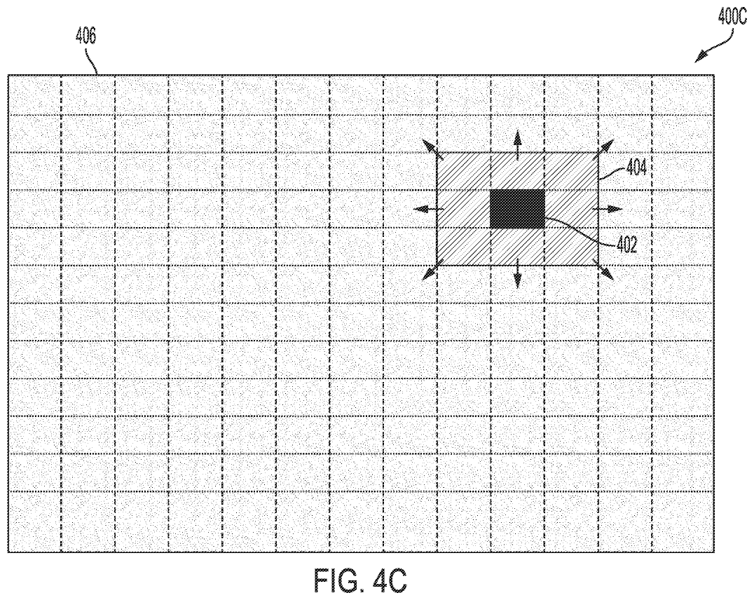

FIGS. 4A-4C illustrate a Q function that is updated responsive to detection of a change in the environment. FIG. 4A illustrates a Q function learned during an initial training by a Q learning function. As shown in FIG. 4A, the environment 400A can be depicted as a series of local instances. Each local instance can represent part of a global Q table specifying a global policy for an agent performing a task as described herein.

Further, either during training of the Q function or after training of the Q function, a change to the environment can be detected. For example, a new object can be introduced into the environment. In such instances, the location of the change to the environment can be mapped to the Q function 400A, such as location 402 as shown in FIG. 4A. As noted above, the changes to the Q table can first be made locally and then propagated globally using a diffusion model to update the Q table across the environment.

FIG. 4B illustrates the Q function 400B with a modified local Q table comprising a local region around the location of the change to the environment. As shown in FIG. 4B, a local region 404 around the location of the change to the environment 402 in the Q function 400B can be identified. Further, the local region 404 (representing a local Q table) can be modified and retrained to account for the change to the environment.

FIG. 4C illustrates the Q function 400C with a modified global Q table based on the change to the environment. As noted above, a diffusion model can be built, and the local changes to the local Q table can be propagated across the global Q table (e.g., 406). The modified global Q table can represent an updated policy that can account for the change to the environment.

In a first example embodiment, a method for updating a learned control policy in response to identifying a change to an environment is provided. The method can include generating a learned control policy for an environment using a reinforcement learning process. The learned control policy can provide a Q table comprising values specifying actions for an agent to take based on a state of the agent in order to complete a task.

In some instances, the agent comprises an unmanned aerial vehicle (UAV). Further, in some instances, the task comprises the UAV moving from an initial location to a target location in the environment. In some instances, the method can include identifying a state of the UAV based on a present location of the UAV in the environment and determining an action for the UAV based on mapping the state of the UAV to the Q table. In some instances, a reward is issued upon completion of the task, and wherein an amount of the reward is determined based on a length of a path traveled by the UAV in completion of the task.

The method can also include detecting a change to the environment at a first location in the environment. In some instances, the change to the environment comprises a new object being identified at the first location in the environment. In some instances, the method can include receiving, from an image sensor of the agent, an image of the environment and processing the image to identify the new object at the first location in the environment.

The method can also include defining a local region surrounding the first location, wherein the local region corresponds with a local Q table that is part of the Q table.

The method can also include modifying the local Q table using the reinforcement learning process based on the detected change to the environment. In some instances, the reinforcement learning process comprises a Q learning process. In some instances, each local region in the environment corresponds to a cell in the Q table.

The method can also include generating a diffusion model for propagating changes made in the local Q table across the Q table.

The method can also include propagating, using the diffusion model, the changes made in the local Q table globally across the Q table to modify the learned control policy.

In another example embodiment, a system is provided. The system can include at least one unmanned aerial vehicle (UAV) and a computer in electrical communication with the at least one UAV. The computer is operative to detect a change to the environment at a first location in the environment. A learned control policy for the environment includes a Q table that comprises values specifying actions for an UAV to take based on a state for the UAV to complete a task.

In some instances, the task comprises the UAV delivering a payload from an initial location to a target location in the environment, and wherein the state of the UAV is based on a current location of the UAV in the environment. In some instances, the computer is further operative to identify the state of the UAV based on current location of the UAV in the environment and determine an action for the UAV based on mapping the state of the UAV to the Q table. In some instances, a reward is issued upon completion of the task. An amount of the reward is determined based on a length of a path traveled by the UAV in completion of the task.

The computer is further operative to define a local region surrounding the first location. The local region can correspond with a local Q table that is part of the Q table. The computer is further operative to modify the local Q table using the Q learning process based on the change to the environment.

The computer is further operative to propagate any changes made in the local Q table globally across the Q table to modify the learned control policy. In some instances, the computer is further operative to generate a diffusion model for propagating any changes made in the local Q table across the Q table.

Another example embodiment provides a computer-readable storage medium. The computer-readable storage medium can contain program instructions for a method being executed by an application, the application comprising code for one or more components that are called by the application during runtime, wherein execution of the program instructions by one or more processors of a computer system causes the one or more processors to perform steps.

The steps can include generating a learned control policy for an environment using a reinforcement learning process. The learned control policy can provide a Q table comprising values specifying actions for an agent to take based on a state of the agent in order to complete a task.

In some instances, the agent comprises an unmanned aerial vehicle (UAV). In some instances, the task comprises the UAV moving from an initial location to a target location in the environment. In some instances, the steps can also include identifying a state of the UAV based on a present location of the UAV in the environment and determining an action for the UAV based on mapping the state of the UAV to the Q table.

The steps can also include detecting a change to the environment at a first location in the environment by receiving, from an image sensor of the agent, an image of the environment and processing the image to identify the new object at the first location in the environment.

In some instances, the change to the environment comprises a new object being identified at the first location in the environment. In some instances, each position in the environment corresponds to a cell in the Q table.

The steps can also include defining a local region surrounding the first location. The local region can correspond with a local Q table that is part of the Q table. The steps can also include modifying the local Q table using the reinforcement learning process based on the detected change to the environment.

The steps can also include generating a diffusion model for propagating changes made in the local Q table across the Q table. The steps can also include propagating, using the diffusion model, the changes made in the local Q table globally across the Q table to modify the learned control policy.

### Computing System Overview

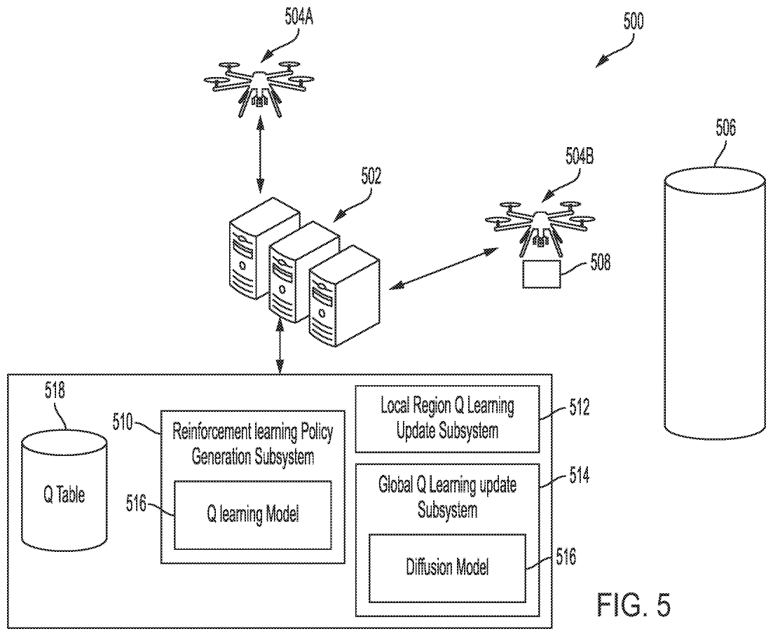

As described above, the system can include a computing node or series of interconnected computing nodes capable of performing a series of steps as described herein. FIG. 5 illustrates an example system for implementing a Q learning technique in a dynamically changing environment. As shown in FIG. 5, the system 500 can include a computing node 502, UAVs 504A-B, and one or more obstacles (e.g., 506) in the environment. Each agent 504A-B can be configured to move about the environment in performance of a task. A Q learning policy can be generated to provide a reinforcement learning technique for completing the task while prioritizing efficiency in performing the task to maximize a reward.

Further, in many cases, the policy can be generated for an environment in a first configuration. However, in the event a new obstacle (e.g., obstacle 506) is identified in the environment, the policy may be updated as described herein.

The system can interact with one or more agents, such as UAVs 504A-B or other similar vehicles. The UAVs can be configured to move about the environment and perform a task, such as to deliver a payload at a target location, for example. The agents can include one or more sensors, such as an imaging sensor 508. The imaging sensor 508 can capture images, which can be subsequently processed to identify an obstacle (e.g., 506) in the path and report back that an obstacle exists on the path. In some instances, the obstacle (and a location of the obstacle) can be detected or otherwise reported to the computing node 502.

The computing node 502 can store a Q table 518. The Q table 518 can include a table depicting characteristics of the environment. For example, the Q table 518 can provide values specifying actions capable of being taken at a specific position based on bounds and objects in the environment. As the agent moves to a new region, the state of the agent can change, and a determination for an action can be made based on the Q table and the current location of the agent in relation to the target location. The action taken can be maximized using the Q table to find a shortest path to maximize a reward.

The computing node 502 can also include a reinforcement learning policy generation subsystem 510. The reinforcement learning policy generation subsystem 510 can incorporate a reinforcement learning model (or Q learning model 516) to generate an initial policy for the environment. The reinforcement learning policy generation subsystem 510 can also generate a corresponding Q table.

The computing node 502 can also include a local region Q learning update subsystem 512. The local region Q learning update subsystem 512 can identify a change in the environment. For example, a change in the environment can be identifying (by a UAV image sensor 508 or by a report received from another device) a new obstacle 506 in the environment. The local region Q learning update subsystem 512 can also identify a position of the change to the environment and map that position to a local region in the Q table 518. A local region can be identified around the location of the change in the environment. Further, the local region Q learning update subsystem 512 can update the local region (and the corresponding local Q table) based on the change to the environment.

The computing node 502 can also include a global Q learning update subsystem 514. The global Q learning update subsystem 514 can build a diffusion model 516 to propagate the changes made in the local Q table globally across the Q table.

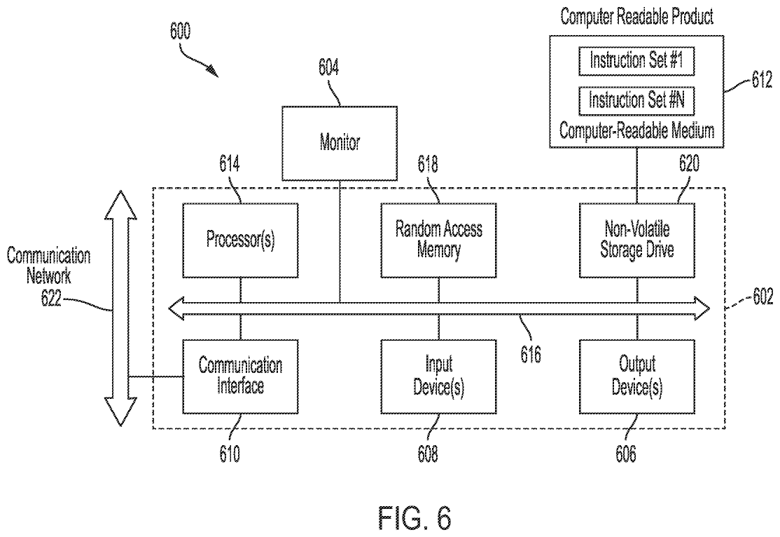

FIG. 6 is a block diagram of a special-purpose computer system 600 according to an embodiment. The computer system 600 can include features similar to a computing node as described herein. The methods and processes described herein may similarly be implemented by tangible, non-transitory computer readable storage mediums and/or computer-program products that direct a computer system to perform the actions of the methods and processes described herein. Each such computer-program product may comprise sets of instructions (e.g., codes) embodied on a computer-readable medium that directs the processor of a computer system to perform corresponding operations. The instructions may be configured to run in sequential order, or in parallel (such as under different processing threads), or in a combination thereof.

Special-purpose computer system 600 comprises a computer 602, a monitor 604 coupled to computer 602, one or more additional user output devices 606 (optional) coupled to computer 602, one or more user input devices 608 (e.g., keyboard, mouse, track ball, touch screen) coupled to computer 602, an optional communications interface 610 coupled to computer 602, and a computer-program product including a tangible computer-readable storage medium 612 in or accessible to computer 602. Instructions stored on computer-readable storage medium 612 may direct system 600 to perform the methods and processes described herein. Computer 602 may include one or more processors 614 that communicate with a number of peripheral devices via a bus subsystem 616. These peripheral devices may include user output device(s) 606, user input device(s) 608, communications interface 610, and a storage subsystem, such as random-access memory (RAM) 618 and non-volatile storage drive 620 (e.g., disk drive, optical drive, solid state drive), which are forms of tangible computer-readable memory.

Computer-readable medium 612 may be loaded into random access memory 618, stored in non-volatile storage drive 620, or otherwise accessible to one or more components of computer 602. Each processor 614 may comprise a microprocessor, such as a microprocessor from Intel® or Advanced Micro Devices, Inc.®, or the like. To support computer-readable medium 612, the computer 602 runs an operating system that handles the communications between computer-readable medium 612 and the above-noted components, as well as the communications between the above-noted components in support of the computer-readable medium 612. Exemplary operating systems include Windows® or the like from Microsoft Corporation, Solaris® from Sun Microsystems, LINUX, UNIX, and the like. In many embodiments and as described herein, the computer-program product may be an apparatus (e.g., a hard drive including case, read/write head, etc., a computer disc including case, a memory card including connector, case, etc.) that includes a computer-readable medium (e.g., a disk, a memory chip, etc.). In other embodiments, a computer-program product may comprise the instruction sets, or code modules, themselves, and be embodied on a computer-readable medium.

User input devices 608 include all possible types of devices and mechanisms to input information to computer system 602. These may include a keyboard, a keypad, a mouse, a scanner, a digital drawing pad, a touch screen incorporated into the display, audio input devices such as voice recognition systems, microphones, and other types of input devices. In various embodiments, user input devices 608 are typically embodied as a computer mouse, a trackball, a track pad, a joystick, wireless remote, a drawing tablet, a voice command system. User input devices 608 typically allow a user to select objects, icons, text and the like that appear on the monitor 604 via a command such as a click of a button or the like. User output devices 606 include all possible types of devices and mechanisms to output information from computer 602. These may include a display (e.g., monitor 604), printers, non-visual displays such as audio output devices, etc.

Communications interface 610 provides an interface to other communication networks and devices and may serve as an interface to receive data from and transmit data to other systems, WANs and/or the Internet, via a wired or wireless communication network 622. In addition, communications interface 610 can include an underwater radio for transmitting and receiving data in an underwater network. Embodiments of communications interface 610 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 610 may be coupled to a computer network, to a Fire Wire® bus, or the like. In other embodiments, communications interface 610 may be physically integrated on the motherboard of computer 602, and/or may be a software program, or the like.

RAM 618 and non-volatile storage drive 620 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 618 and non-volatile storage drive 620 may be configured to store the basic programming and data constructs that provide the functionality of various embodiments of the present invention, as described above.

Software instruction sets that provide the functionality of the present invention may be stored in computer-readable medium 612, RAM 618, and/or non-volatile storage drive 620. These instruction sets or code may be executed by the processor(s) 614. Computer-readable medium 612, RAM 618, and/or non-volatile storage drive 620 may also provide a repository to store data and data structures used in accordance with the present invention. RAM 618 and non-volatile storage drive 620 may include a number of memories including a main random-access memory (RAM) to store instructions and data during program execution and a read-only memory (ROM) in which fixed instructions are stored. RAM 618 and non-volatile storage drive 620 may include a file storage subsystem providing persistent (non-volatile) storage of program and/or data files. RAM 618 and non-volatile storage drive 620 may also include removable storage systems, such as removable flash memory.

Bus subsystem 616 provides a mechanism to allow the various components and subsystems of computer 602 communicate with each other as intended. Although bus subsystem 616 is shown schematically as a single bus, alternative embodiments of the bus subsystem may utilize multiple busses or communication paths within the computer 602.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, wireless channels, and/or various other storage mediums capable of storing that contain or carry instruction(s) and/or data.

### Conclusion

Whereas many alterations and modifications of the present invention will no doubt become apparent to a person of ordinary skill in the art after having read the foregoing description, it is to be understood that the particular embodiments shown and described by way of illustration are in no way intended to be considered limiting.

Moreover, the processes described above, as well as any other aspects of the disclosure, may each be implemented by software, but may also be implemented in hardware, firmware, or any combination of software, hardware, and firmware. Instructions for performing these processes may also be embodied as machine-or computer-readable code recorded on a machine-or computer-readable medium. In some embodiments, the computer-readable medium may be a non-transitory computer-readable medium. Examples of such a non-transitory computer-readable medium include but are not limited to a read-only memory, a random-access memory, a flash memory, a CD-ROM, a DVD, a magnetic tape, a removable memory card, and optical data storage devices. In other embodiments, the computer-readable medium may be a transitory computer-readable medium. In such embodiments, the transitory computer-readable medium can be distributed over network-coupled computer systems so that the computer-readable code is stored and executed in a distributed fashion. For example, such a transitory computer-readable medium may be communicated from one electronic device to another electronic device using any suitable communications protocol. Such a transitory computer-readable medium may embody computer-readable code, instructions, data structures, program modules, or other data in a modulated data signal, such as a carrier wave or other transport mechanism, and may include any information delivery media. A modulated data signal may be a signal that has one or more of its characteristics set or changed in such a manner as to encode information in the signal.

It is to be understood that any or each module of any one or more of any system, device, or server may be provided as a software construct, firmware construct, one or more hardware components, or a combination thereof, and may be described in the general context of computer-executable instructions, such as program modules, that may be executed by one or more computers or other devices. Generally, a program module may include one or more routines, programs, objects, components, and/or data structures that may perform one or more particular tasks or that may implement one or more particular abstract data types. It is also to be understood that the number, configuration, functionality, and interconnection of the modules of any one or more of any system, device, or server are merely illustrative, and that the number, configuration, functionality, and interconnection of existing modules may be modified or omitted, additional modules may be added, and the interconnection of certain modules may be altered.

While there have been described systems, methods, and computer-readable media for enabling efficient control of a media application at a media electronic device by a user electronic device, it is to be understood that many changes may be made therein without departing from the spirit and scope of the disclosure. Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

Therefore, those skilled in the art will appreciate that the invention can be practiced by other than the described embodiments, which are presented for purposes of illustration rather than of limitation.

What is claimed is:

1. A method for updating a learned control policy in response to identifying a change to an environment, the method comprising:
generating the learned control policy for the environment using a reinforcement learning process, wherein the learned control policy provides a Q table comprising values specifying actions for an agent to take based on a state of the agent in order to complete a task;
detecting a change to the environment at a first location in the environment;
defining a local region surrounding the first location, wherein the local region corresponds with a local Q table that is part of the Q table;
modifying the local Q table using the reinforcement learning process based on the detected change to the environment;
generating a diffusion model for propagating changes made in the local Q table across the Q table; and
propagating, using the diffusion model, the changes made in the local Q table globally across the Q table to modify the learned control policy.

2. The method of claim 1, wherein the agent comprises an unmanned aerial vehicle (UAV).

3. The method of claim 2, wherein the task comprises the UAV moving from an initial location to a target location in the environment.

4. The method of claim 3, further comprising:
identifying the state of the UAV based on a present location of the UAV in the environment; and
determining an action for the UAV based on mapping the state of the UAV to the Q table.

5. The method of claim 3, wherein a reward is issued upon completion of the task, and wherein an amount of the reward is determined based on a length of a path traveled by the UAV in completion of the task.

6. The method of claim 1, wherein the reinforcement learning process comprises a Q learning process.

7. The method of claim 1, wherein the change to the environment comprises a new object being identified at the first location in the environment.

8. The method of claim 7, further comprising:
receiving, from an image sensor of the agent, an image of the environment; and
processing the image to identify the new object at the first location in the environment.

9. The method of claim 1, wherein each location in the environment corresponds to a cell in the Q table.

10. A system comprising:
at least one unmanned aerial vehicle (UAV); and
a computer in electrical communication with the at least one UAV, where the computer is operative to:
detect a change to an environment at a first location in the environment, wherein a learned control policy for the environment includes a Q table that comprises values specifying actions for an UAV to take based on a state for the UAV to complete a task;
define a local region surrounding the first location, wherein the local region corresponds with a local Q table that is part of the Q table;
modify the local Q table using a Q learning process based on the change to the environment; and
propagate any changes made in the local Q table globally across the Q table to modify the learned control policy.

11. The system of claim 10, wherein the computer is further operative to:
generate a diffusion model for propagating any changes made in the local Q table across the Q table.

12. The system of claim 10, wherein the task comprises the UAV delivering a payload from an initial location to a target location in the environment, and wherein the state of the UAV is based on a current location of the UAV in the environment.

13. The system of claim 12, wherein the computer is further operative to:
identify the state of the UAV based on the current location of the UAV in the environment; and
determine an action for the UAV based on mapping the state of the UAV to the Q table.

14. The system of claim 10, wherein a reward is issued upon completion of the task, and wherein an amount of the reward is determined based on a length of a path traveled by the UAV in completion of the task.

15. A computer-readable storage medium containing program instructions for a method being executed by an application, the application comprising code for one or more components that are called by the application during runtime, wherein execution of the program instructions by one or more processors of a computer system causes the one or more processors to perform steps comprising:
generating a learned control policy for an environment using a reinforcement learning process, wherein the learned control policy provides a Q table comprising values specifying actions for an agent to take based on a state of the agent in order to complete a task;
detecting a change to the environment at a first location in the environment by:
receiving, from an image sensor of the agent, an image of the environment; and
processing the image to identify a new object at the first location in the environment;
defining a local region surrounding the first location, wherein the local region corresponds with a local Q table that is part of the Q table;
modifying the local Q table using the reinforcement learning process based on the detected change to the environment;
generating a diffusion model for propagating changes made in the local Q table across the Q table; and
propagating, using the diffusion model, the changes made in the local Q table globally across the Q table to modify the learned control policy.

16. The computer-readable storage medium of claim 15, wherein the agent comprises an unmanned aerial vehicle (UAV).

17. The computer-readable storage medium of claim 16, wherein the task comprises the UAV moving from an initial location to a target location in the environment.

18. The computer-readable storage medium of claim 17, further comprising:
identifying the state of the UAV based on a present location of the UAV in the environment; and
determining an action for the UAV based on mapping the state of the UAV to the Q table.

19. The computer-readable storage medium of claim 15, wherein the change to the environment comprises a new object being identified at the first location in the environment.

20. The computer-readable storage medium of claim 15, wherein each location in the environment corresponds to a cell in the Q table.
